(19) United States
(12) Patent Application Publication
(10) Pub. No.: US 2015/0106109 A1
(43) Pub. Date: Apr. 16, 2015

(54) Systems and Methods for Lowering the Cost of Health Care

(71) Applicant: Gary and Mary West Health Institute, La Jolla, CA (US)

(72) Inventors: Christopher W. Crowley, JR., San Diego, CA (US); Freeman H. Rose, JR., Del Mar, CA (US); Amy R. Stuck, Cardiff by the Sea, CA (US); Joseph M. Smith, Rancho Santa Fe, CA (US); Jose H. Unpingco, San Diego, CA (US)

(73) Assignee: Gary and Mary West Health Institute, La Jolla, CA (US)

(21) Appl. No.: 14/054,258

(22) Filed: Oct. 15, 2013

(51) Int. Cl. G06Q 50/22

(52) U.S. Cl. CPC G06Q 50/22
USPC 705/2

(57) ABSTRACT

A computer-based system and method are provided for minimizing the overall cost of providing health care for a chronic disease. To do this, an operating point is selected on a ROC curve to classify patients in a defined population. Based on this classification, patients in the population are classified and placed on either of a pair of pathways for health care. One pathway involves relatively low-cost health care treatment, but potentially repetitive involvement with the patient. The other pathway involves relatively high-cost treatment, but only episodic involvement with the patient. Placement of each entity on a selected pathway is done to collectively minimize the overall cost of providing health care.

### FIELD OF THE INVENTION

The present invention pertains generally to systems and methods for minimizing the overall cost of health care services. More particularly, the present invention pertains to systems and methods which incorporate cost considerations (criteria) into a branching process that directs each entity in a population, onto either a pathway for proactive (i.e. preventative) care, which is relatively low cost but potentially repetitive, or onto a pathway for reactive (i.e. direct) care, which though not repetitive may be of relatively high cost. The present invention is particularly, but not exclusively, useful for systems and methods which require the selection of an operating point on a Receiver-Operating Characteristics (ROC) curve for implementing the branching process.

### BACKGROUND OF THE INVENTION

In any buyer-seller transaction, the cost for purchasing something (e.g. goods or services) is known and is determined directly by participants in the transaction. On the other hand, after purchase, the maintenance costs for taking care of whatever was purchased (i.e. an entity) is typically unknown or unpredictable. Moreover, maintenance costs can vary substantially from one entity to another, even though the entities may be the same or similarly situated. However, when a large population of similarly situated entities is considered in its totality, probabilities concerning maintenance costs come into play. Consequently, within the parameters of statistical probabilities, maintenance costs then become somewhat predictable and, therefore, more manageable. In this context, health care costs can be likened somewhat to maintenance costs.

Of particular concern for the present invention are the costs that are associated with health care for chronic diseases. It happens that a useful analytical tool for evaluating the probabilities associated with chronic diseases is the Receiver-Operating Characteristics (ROC) curve. For a defined population of patients having a particular chronic disease, the ROC curve is characteristic of the disease and is essentially a plot of probable outcomes. For example, in the context of the present invention, patients with a chronic disease will require reactive health care only when treatment is needed on an episodic basis. Otherwise, they may be able to control the disease with less expensive proactive (i.e. preventive) health care. Not all patients, however, will similarly benefit from proactive health care; nor may they even actually require proactive health care.

As an analytical tool, the ROC curve can be used to classify an individual (entity). Specifically, within a defined population, and based on test results only, each entity in the population can be divided into an affected subgroup (e.g. positive test result [+]) or an unaffected subgroup (e.g. negative test result [−]). Further, the ROC curve is able to account for such factors as false positives, and false negatives. For purposes of the present invention, the import here is that a population can be effectively and accurately bifurcated based on statistical probabilities.

In light of the above, an object of the present invention is to provide a system and method for conducting an activity (e.g. health care) that uses the ROC curve to classify an entity from a defined population for placement onto a selected action pathway that will minimize the overall cost of conducting the activity. Another objective of the present invention is to effectively and accurately identify a smaller subpopulation of patients who will most likely benefit from lower cost proactive care; to then limit proactive care to this subpopulation; and to thereby reduce or minimize the overall cost of health care. Yet another object of the present invention is to provide a system and method for minimizing the overall cost of implementing a health care program for treating chronic diseases that is easy to use, is simple to implement and is cost effective.

### SUMMARY OF THE INVENTION

In accordance with the present invention, a system and method are provided for evaluating and classifying individuals in a population of patients according to health care cost requirements. The purpose here is to place each patient into an appropriate health care program that will minimize the overall health care costs for the entire population. In particular, the focus of the present invention is on patients with chronic diseases. With this in mind, the present invention is implemented with the understanding that statistical probabilities allow an entire population of patients, all having a same chronic disease, to be individually classified for health care treatment. In particular, the classification for each patient can be based on his/her test results.

In use, the present invention is computer-based, and it relies on data that is pertinent to a particular chronic disease. With this stipulation in mind, a specific population of patients can be effectively defined. Data can then be collected from the population and subsequently organized and archived into a database. In particular, statistical data for a population of patients can be obtained from a plurality of tests that includes static patient data, physiological tests, laboratory tests, non-physiological parameters and multifactorial combinations of parameters.

As envisioned for the present invention, collected data that is pertinent to a particular chronic disease can be used for several purposes. For one, the data can be used to associate health care costs with different treatment regimens. For another, the data can be used to assess the efficacy of a particular treatment regimen for an individual patient. Further, and most importantly, the collected data can be analytically used to classify patients.

For purposes of the present invention, the data that is collected and organized for the database is used to define a pair of treatment (i.e. action) pathways. One of these pathways is specifically defined for proactive care and the other for reactive care. Typically, the proactive care will be routine, and it will be provided on an outpatient basis. Further, the proactive care pathway is designed for use by patients who are most likely to benefit from care that will prevent, or allay, the onset of an episodic event. Importantly, cost criteria for action on the proactive pathway will be considered when defining the parameters for assigning, and accepting, a patient onto the proactive care pathway.

Along with the proactive care pathway, the present invention also requires a reactive care pathway. Specifically, this reactive care pathway is defined to accept acutely ill patients (i.e. patients in or near an episodic condition) who are in need of immediate and direct care. Treatment on the reactive care pathway has few, if any, options and it will most likely involve high health care costs.

Importantly, the present invention relies on the construction of a compound test that is characterized by a ROC curve. In particular, this ROC curve is created in accordance with well-known techniques using data from the population database. More specifically, the ROC curve is based on treatment for a chronic disease and it will be determined by considerations such as the nature of the required proactive treatment regimen and the likelihood of a patient having a positive response to the proactive treatment. Further, like the proactive and reactive pathways, a use of the ROC curve is influenced by cost considerations.

In an operation of the present invention, a population of patients having a same chronic disease is identified. Next, data from the population is collected, and a database is organized. A computerized ROC curve is then established using data from the database. For an operation of the present invention, an operating point selected on the ROC curve is chosen to classify patients. As noted above, it is an important aspect of the present invention that costing factors are incorporated into the creation and definition of the computer output pathways (i.e. the proactive health care pathway, and the reactive health care pathway).

A consequence of the above interactive considerations is that test results for a patient can be provided as a computer input. These patient test results are then compared by the computer with a selected operating point on the ROC curve. The result of this comparison is that the patient is classified for assignment on either of the defined health care pathways for the purpose of collectively minimizing the overall cost of health care.

As envisioned for the present invention, the database can be continuously updated. In this process, patients on either, or both, of the health care pathways can be retested and reclassified. Thus, an iterative process is established that effectively allows an entire population to be periodically reevaluated and reformed, in-whole or in-part. At any point, the reformed population can then be further subjected to a subsequent bifurcation for possible reclassification.

To do the above, various testing procedures can be incorporated into the present invention. Further, the organization of data in the database and the implementation of cost criteria considerations into the data evaluations can be continuously revised and updated to provide for the most cost effective implementation of health care services. An important consequence here is that historical information developed during a continuous operation of the system can be used to refine the population.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic presentation of the computer components for a system of the present invention, showing essential inputs for an operation of the system; and

FIG. 2 is a representative ROC curve that is pertinent to a specific chronic disease and is used in the methodology of the present invention to establish the relationship between the Probability of Detecting (PD) an episodic deterioration of the disease and the Probability of a False Alarm (PFA).

### DESCRIPTION OF THE PREFERRED EMBODIMENTS

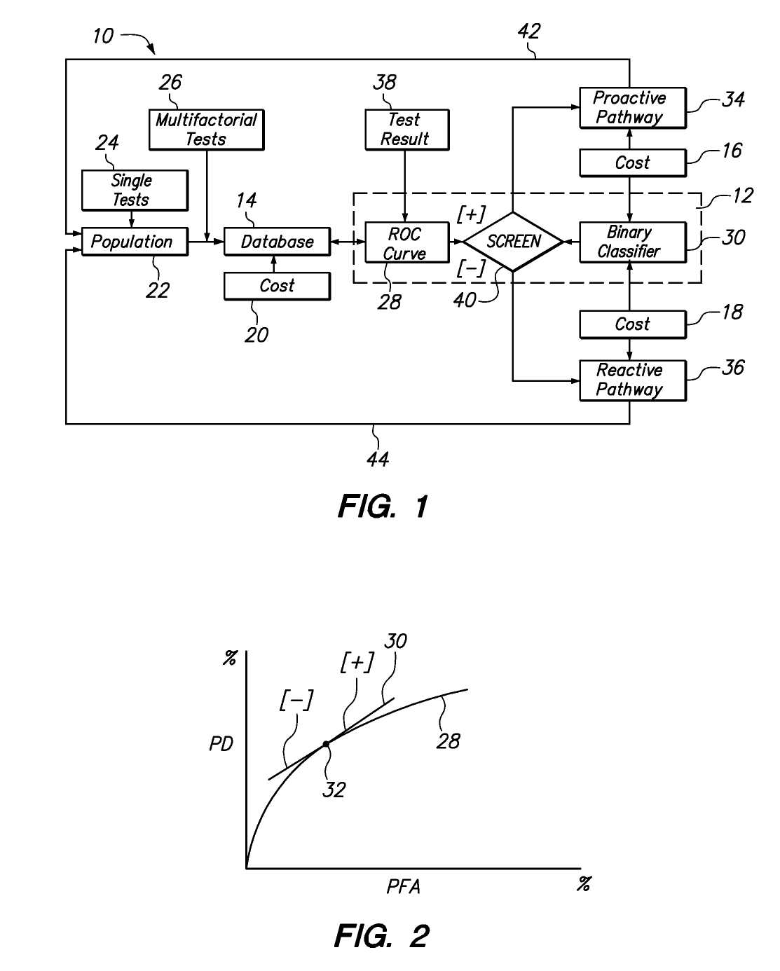

Referring initially to FIG. 1, a schematic representation of a system in accordance with the present invention is shown and is generally designated 10. In FIG. 1 it will be seen that the system 10 includes a computer 12 which is provided with the various information inputs required for an operational set-up of the computer 12. In detail, these inputs include data from a database 14, and cost criteria 16 that are pertinent to relatively low cost health care regimens, as well as cost criteria 18 that are pertinent to relatively high cost health care regimens. Insofar as costs are concerned, FIG. 1 also shows that generalized health care costs 20 are provided as input for the database 14.

With specific regard to the database 14 in FIG. 1, its input of generalized health care costs 20 is pertinent to a particular chronic disease (e.g. diabetes or heart disease) and this input will comprehensively include cost estimates for all aspects of the disease. On the other hand, the cost criteria 16 which are input for the computer 12 will be more focused in their estimations, and will be directed to the costs for regimens of health care treatment that are intended to be preventative (i.e. proactive) in nature. In particular, these cost criteria 16 will be relatively low, and will typically support outpatient care that is to be provided on a routine and, possibly, protracted basis. Similarly, the cost criteria 18 input for the computer 12 will also be focused in their estimations. In this case, however, the cost criteria 18 will be directed to the costs for regimens of health care treatment that are necessarily immediate and direct (i.e. reactive). For example, reactive health care is necessary for immediate response to an episodic presentation of the chronic disease. Consequently, cost criteria 18 will be relatively high, and will typically be driven by costs which are associated with emergency and surgical requirements.

An important aspect of the present invention is the population 22 for whom the system 10 is operated. In detail, the population 22 will include all patients identified as having a same chronic disease. It is the population 22 that provides data for the database 14. The data in this case comes from single tests 24 that include static patient data, physiological tests, laboratory tests and non-physiological parameters. Additionally, multifactorial tests 26, involving combinations of various parameters, are included in this data. In accordance with the purposes of the present invention, these multifactorial tests 26 are pertinent to a chronic disease and, accordingly, are used to create a compound test that is ultimately characterized by a Receiver-Operating Characteristics (ROC) curve 28. It is to be noted here that although the system 10 disclosed is primarily concerned with a same chronic disease, it is envisioned by the present invention that different systems 10, pertaining to respectively different chronic diseases, can be operationally combined for cost management purposes. Moreover, different diseases can conceivably be considered and evaluated in the same system 10. With this in mind, the operational flexibility of any system 10 will depend on how the population 22 is defined, and how the cost considerations (i.e. cost criteria 16, cost criteria 18 and generalized costs 20) are employed.

FIG. 1 shows that the computer 12 interacts directly with the database 14 to generate a plot for the Receiver-Operating Characteristic (ROC) curve 28. As indicated in FIG. 1, the population 22, the multifactorial tests 26, and the generalized costs 20 all provide respectively appropriate inputs to the database 14 for this purpose. The computer 12 then uses these inputs to generate (i.e. plot) the ROC curve 28. ROC curve 28 shown in FIG. 2 is only exemplary. As shown and adapted for use with the present invention, the ROC curve 28 is based primarily on multifactorial tests 26, and it pertains to the particular chronic disease associated with the population 22. In essence, the ROC curve 28 is a plot of the Probability of Detection (PD) versus Probability of a False Alarm (PFA). The generation and plotting of ROC curves are well known in the pertinent art. As noted above, the specific purpose for generating the ROC curve 28 for use with the system 10 is to provide an analytical tool for classifying patients in the population 22.

With reference to FIG. 2 it will be appreciated that a binary classifier 30 can be selected by the computer 12 to interact with the ROC curve 28. Specifically, as directed by the computer 12, the binary classifier 30 will identify an operating point (threshold) 32 on the ROC curve 28 that effectively bifurcates the population 22 into two subpopulations (i.e. subgroups). With this bifurcation, one subpopulation will be classified by the computer 12 with a positive result [+], and the other will be classified with a negative result [−].

Referring again to FIG. 1, it will be seen that system 10 of the present invention provides for both a proactive pathway 34 and a reactive pathway 36. Together, this pair of pathways, 34 and 36, is defined to provide health care services for the entire population 22. In particular, patients with a positive screening result [+] are assigned to the proactive pathway 34, while the remainder (i.e. those patients with negative screening results [−]) are assigned to the reactive pathway 36. As indicated above, and shown in FIG. 1, the particular health care services that are provided on the proactive pathway 34 are characterized by the cost criteria 16. On the other hand, the health care services provided on the reactive pathway 36 are characterized by the cost criteria 18. In light of these respective cost considerations, the operating point 32 is selected by the computer 12 to identify patients, [+], who are most likely to benefit from an assignment to the proactive pathway 34 and, accordingly, to assign them to the proactive pathway 34 for health care. The remaining patients, [−], would therefore be assigned to the reactive pathway 36. The objective here, of course, is to provide all necessary health care, and at the same time minimize the overall cost of health care for the population 22.

In an operation of the system 10, a population 22 is defined. Statistical data pertinent to the defined population 22 is organized and archived in the database 14. Next, the ROC curve 28 is established by the computer 12 using data from the database 14 (i.e. multifactorial tests 26). A pair of alternative action pathways (i.e. proactive pathway 34, and reactive pathway 36) is defined with computer input for conducting a health care activity. Specifically, each defined pathway, 34 and 36, has a respective cost associated with action on the pathway. A patient is then tested to obtain a test result 38 for the patient. This test result 38 is then evaluated using a screen 40 of the computer 12 to compare the test result 38 with the operating point 32 of the binary classifier 30 on the ROC curve 28. With this comparison, the patient is classified, [+] or [−], according to a bifurcation determined by the binary classifier 30. The patient is then directed, according to his/her classification, onto either the proactive pathway 34 or the reactive pathway 36 to minimize an overall cost for treating the chronic disease. As envisioned for the present invention, patients on the proactive pathway 34 and/or on the reactive pathway 36 can be periodically retested and rescreened to remain on the particular pathway, or for transfer to the other pathway.

It is also an important aspect of the present invention that the system 10, itself, is dynamic. In particular, during an operation of the system 10, the population 22 can be selectively reevaluated and, possibly, reclassified. This can be done at any time, and can be repetitively accomplished in a manner determined by the operator of the system 10. As envisioned for the present invention, this reevaluation can be done daily, weekly or monthly.

As indicated in FIG. 1, the reevaluation and possible reclassification of the population 22 involves a manipulation of data by the computer 12. Specifically, data pertaining to individuals (patients) on the proactive pathway 34 can be removed from the proactive pathway 34 and returned to the population 22 via a return line 42. Similarly, data pertaining to individuals (patients) on the reactive pathway 36 can be removed from the reactive pathway 36 and returned to the population 22 via a return line 44. In both instances, data for the individual (patient) reenters the population 22 for reprocessing and reformation of the population 22.

As envisioned for the present invention, an operation of the system 10 is iterative, and it can simultaneously involve both the proactive pathway 34 and the reactive pathway 36. Alternatively, it may involve only one pathway at a time (i.e. proactive pathway 34 or reactive pathway 36). Further, the entire process can be repeated as necessary or desired.

A consequential benefit of the iterative process described above is that the results of prior classifications (bifurcations) can be archived and organized in the database 14. The results of these prior bifurcations are therefore dynamically available as direct or indirect input to the computer 12 in real time. Importantly, the availability of this information is useful for continuously updating and refining the ROC curve 28 and, if desired, a reselection of the operating point 32 on the ROC curve 28.

While the particular Systems and Methods for Lowering the Cost of Health Care as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for minimizing the overall cost of conducting a health care activity which comprises:
a database for archiving and organizing statistical data pertinent to the activity, wherein the database is for a defined population and is used to establish and maintain a Receiver-Operating Characteristic (ROC) curve, and wherein the population includes a plurality of patients;
a means for testing a patient to obtain a test result for the patient;
a pair of alternative pathways for conducting the health care activity, wherein each pathway has a cost associated with action on the pathway; and
a computer for comparing the test result for the patient with an operating point on the ROC curve to classify the patient according to a bifurcation, and to direct each patient onto a pathway to minimize an overall cost for conducting the activity.

2. A system as recited in claim 1 wherein a patient is placed on a first pathway for conducting an action to prevent an event in the activity, and alternatively, the patient is placed on a second pathway for conducting a reaction to alter the event.

3. A system as recited in claim 2 wherein the event is an episodic occurrence of a chronic disease.

4. A system as recited in claim 2 wherein patients on the first pathway are selectively reclassified for replacement on the first pathway, and alternatively, for transfer to the second pathway.

5. A system as recited in claim 2 wherein patients on the first pathway and patients on the second pathway are tested for reclassification by the computer.

6. A system as recited in claim 2 wherein the ROC curve accounts for probabilities associated with false positive and false negative test results.

7. A system as recited in claim 6 wherein the population includes patients having a chronic disease.

8. A system as recited in claim 7 wherein the ROC curve is based on multifactorial tests.

9. A system as recited in claim 7 wherein the statistical data is obtained from a plurality of tests selected from the group consisting of static patient data, physiological tests, laboratory tests, non-physiological parameters and multifactorial combinations of parameters.

10. A system as recited in claim 9 wherein the database is continuously updated.

11. A method for minimizing the overall cost of conducting a health care activity which comprises the steps of:
defining a population, wherein the population includes a plurality of patients;
organizing statistical data pertinent to the defined population;
archiving the statistical data in a database;
establishing a Receiver-Operating Characteristic (ROC) curve based on data in the database;
identifying a pair of alternative pathways for conducting the health care activity, wherein each pathway has a cost associated with action on the pathway;
testing a patient to obtain a test result for the patient;
comparing the test result for the patient with an operating point of a binary classifier on the ROC curve to classify the patient according to a bifurcation determined by the binary classifier, wherein the classification is based on a likelihood for an occurrence of an event; and
directing the patient onto a pathway to minimize an overall cost for conducting the activity.

12. A method as recited in claim 11 wherein the event is an episodic occurrence of a chronic disease, and wherein the directing step further comprises the steps of:
placing patients on a first pathway for an action to prevent the event; and
alternatively placing patients on a second pathway for a reaction to alter the event.

13. A method as recited in claim 12 further comprising the step of periodically rescreening entities on the first pathway for replacement on the first pathway, and alternatively, for transfer to the second pathway.

14. A method as recited in claim 13 wherein all entities on the first and the second pathway are tested for reclassification in the comparing step.

15. A method as recited in claim 11 wherein the ROC curve accounts for probabilities associated with false positive and false negative test results.

16. A method as recited in claim 12 wherein the statistical data is obtained from a plurality of tests selected from the group consisting of static patient data, physiological tests, laboratory tests, non-physiological parameters and multifactorial combinations of parameters, and wherein the database is continuously updated.

17. A computer program product for use with a computer to minimize the overall cost of providing health care for a chronic disease which comprises computer program sections for respectively:
organizing statistical data pertinent to a defined population, wherein the population includes a plurality of patients;
establishing a Receiver-Operating Characteristic (ROC) curve based on the statistical data;
defining a pair of alternative pathways for providing health care, wherein each pathway has a cost associated with action on the pathway; and
comparing a test result for a patient with an operating point of a binary classifier on the ROC curve to classify the patient according to a bifurcation determined by the binary classifier, wherein the classification is based on a likelihood for an occurrence of an event, and the classification is used to direct the patient onto a pathway to minimize an overall cost for providing health care.

18. A computer program product as recited in claim 17 wherein the patient is placed on a first pathway for an action to prevent the event, and alternatively, is placed on a second pathway for a reaction to alter the event.

19. A computer program product as recited in claim 18 further comprising a computer program section to account for probabilities associated with false positive and false negative test results when establishing the ROC curve.

20. A computer program product as recited in claim 19 wherein the statistical data is obtained from a plurality of tests selected from the group consisting of static patient data, physiological tests, laboratory tests, non-physiological parameters and multifactorial combinations of parameters, and wherein the database is continuously updated.
